(19) United States
(12) Patent Application Publication
(10) Pub. No.: US 2015/0161006 A1
(43) Pub. Date: Jun. 11, 2015

(54) INFORMATION PROCESSING APPARATUS AND METHOD FOR TESTING SAME

(71) Applicant: FUJITSU LIMITED, Kawasaki-shi (JP)

(72) Inventors: Akira NAKAMIZU, Yokohama (JP); Tatsuki KOBAYASHI, Kawasaki (JP); Tetsuya MORIOKA, Kawasaki (JP); Hiroki NARITA, Kawasaki (JP)

(21) Appl. No.: 14/524,007

(22) Filed: Oct. 27, 2014

(30) Foreign Application Priority Data
Dec. 5, 2013 (JP) 2013-251685

(51) Int. Cl. G06F 11/14; G06F 12/08

(52) U.S. Cl. CPC G06F 11/1405; G06F 11/1412; G06F 12/0875; G06F 2212/452

(57) ABSTRACT

A method is provided for testing a processor of an information processing apparatus that includes a cache memory, a first memory, and a second memory. Backups of a first instruction sequence and first data that, when a modification is made thereto, is incapable of being recovered using an instruction sequence held in the first memory are made in the second memory, the second memory being not accessed by the cache memory. In causing the processor to execute the instruction sequence, a second instruction sequence and second data that is fetched and put in the cache memory is modified. While the processor is executing the instruction sequence, when an error occurs due to a modification in a third instruction sequence that is incapable of being recovered using the instruction sequence, the first instruction sequence in the second memory is written to the first memory.

### CROSS-REFERENCE TO RELATED APPLICATION

This application is based upon and claims the benefit of priority of the prior Japanese Patent Application No. 2013-251685, filed on Dec. 5, 2013, the entire contents of which are incorporated herein by reference.

### FIELD

The embodiments discussed herein are related to a test of a Central Processing Unit (CPU).

### BACKGROUND

Chips for use in a server apparatus or the like may include a plurality of CPUs and a plurality of cache memories such as primary and secondary caches. The plurality of CPUs and the plurality of cache memories perform processing in cooperation with each other. When an error occurs in processing performed by the CPUs, the CPUs need to perform various types of processing in accordance with the position and situation of the occurrence.

Processing performed by a CPU may be inspected by intentionally causing an error corresponding to a phenomenon to be inspected. A test for inspecting processing performed by a CPU is called a CPU transaction test. In the CPU transaction test, a test instruction sequence held in a memory is held in a cache when the sequence is executed. When a CPU performs processing, the test instruction sequence is updated by, for example, writing a calculation result. Then, the updated test instruction sequence is written to the memory. Hence, the transaction test needs to be performed after considering the fact that the test instruction sequence goes in and out of the cache, and this makes it difficult to perform the test efficiently.

A known technology related to a test of a cache is a technology wherein a test procedure is put in a non-cache-target region to prevent a test instruction sequence from being updated (see, for example, patent document 1).

Another known technology related to a test of a cache is a technology wherein a test is performed under a condition in which test data is put in a cache memory and a test code is put in an extended memory region (see, for example, patent document 2).

Patent document 1: Japanese Laid-open Patent Publication No. 05-342039

Patent document 2: Japanese Laid-open Patent Publication No. 06-044147

### SUMMARY

According to an aspect of the embodiments, a method is provided for testing a processor of an information processing apparatus that includes a cache memory, a first memory, and a second memory. From among instruction sequence that is held in the first memory and data that is held in the first memory and that is to be used to process the instruction sequence, backups of a first instruction sequence and first data that, when a modification is made thereto, is incapable of being recovered using the instruction sequence held in the first memory are made in the second memory, the second memory being not accessed by the cache memory. In causing the processor to execute the instruction sequence held in the first memory, a second instruction sequence and second data that is fetched and put in the cache memory is modified at predetermined timings. While the processor is executing the instruction sequence held in the first memory, when an error occurs due to a modification in a third instruction sequence that is incapable of being recovered using the instruction sequence held in the first memory, the first instruction sequence for which a backup has been made in the second memory is written to the first memory. When an error occurs due to a modification in a fourth instruction sequence or fourth data that can be recovered using the instruction sequence and the data held in the first memory, the fourth instruction sequence or the fourth data that is a cause of the error is recovered using the instruction sequence and the data held in the first memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a CPU transaction test in accordance with an embodiment.

FIG. 2 illustrates an exemplary hardware configuration of a server apparatus.

FIG. 3 is an explanatory diagram of an exemplary error case detected in a transaction test.

FIG. 4 is an explanatory diagram of an example of management information in accordance with an embodiment.

FIG. 5 is a flowchart illustrating an example of a CPU transaction test in accordance with an embodiment (example 1).

FIG. 6 is a flowchart illustrating an example of a CPU transaction test in accordance with an embodiment (example 2).

FIG. 7 is a flowchart illustrating an example of a CPU transaction test in accordance with an embodiment (example 3).

### DESCRIPTION OF EMBODIMENTS

When a CPU is caused to read an instruction sequence that causes an error in the CPU so as to inspect processing performed by the CPU, the instruction sequence that causes the error is written to a cache in some cases. This could lead to a risk of writing to a memory the instruction sequence that causes the error. Writing the instruction sequence that causes the error to a memory results in a problem wherein the test is incapable of being continued.

In a case where an error corresponding to a phenomenon to be inspected is intentionally caused, the error occurs due to an instruction sequence and data to be used to process the instruction sequence. Technologies related to patent documents 1 and 2 have a problem wherein a test is incapable of being continued when data that causes an error in a CPU is written to a memory. In one aspect, an object of the embodiments is to perform a test of a CPU efficiently.

The following will describe embodiments in detail with reference the drawings.

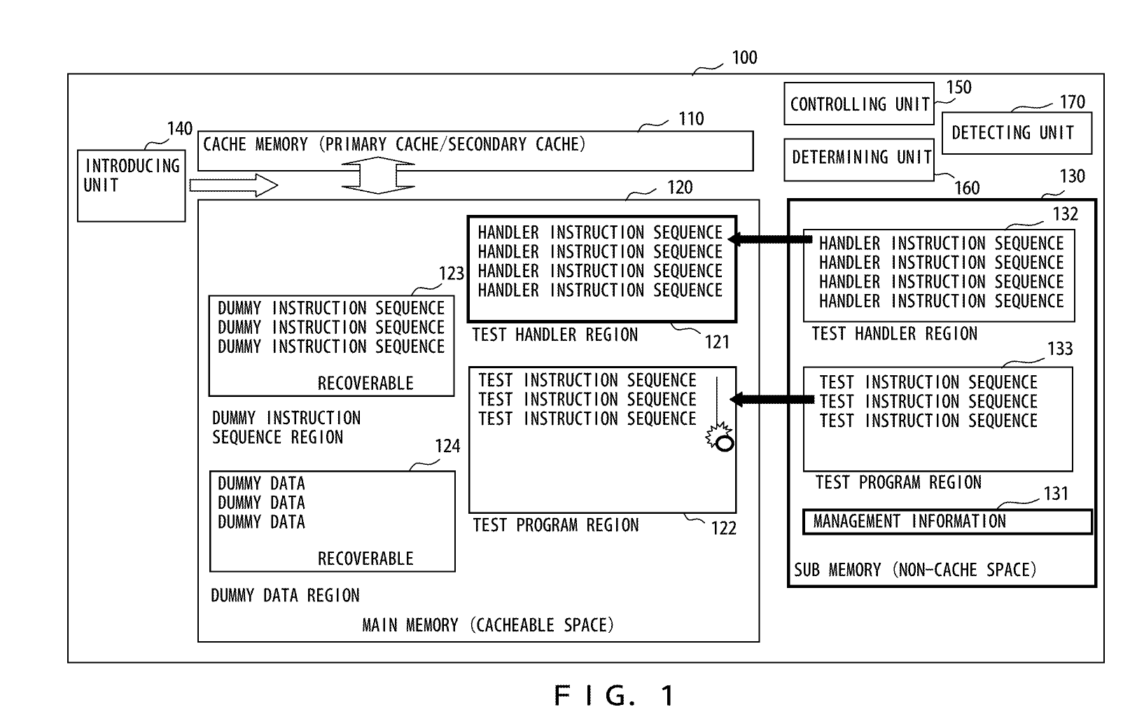

FIG. 1 illustrates an example of a CPU transaction test in accordance with an embodiment. A server apparatus 100 includes a cache memory 110, a main memory 120, a sub memory 130, a controlling unit 150, a determining unit 160, and a detecting unit 170. The cache memory 110 is a cache memory such as a primary cache or a secondary cache. The main memory 120 is a memory apparatus that is capable of caching data in the cache memory 110. The main memory 120 includes a test handler region 121, a test program region 122, a dummy instruction sequence region 123, and a dummy data region 124. The test program region 122 stores a test instruction sequence, which is an instruction sequence in which test details of a transaction test are programmed. The test handler region 121 stores a handler instruction sequence executed when an error is detected. The dummy instruction sequence region 123 stores a dummy instruction sequence to be used to process a test instruction sequence. The dummy instruction sequence region 123 may store identical dummy instruction sequences only. The dummy data region 124 stores dummy data to be used to process a test instruction sequence. All pieces of dummy data stored in the dummy data region 124 may be identical with each other.

The controlling unit 150 controls the entirety of a test that uses a test instruction sequence, a handler instruction sequence, a dummy instruction sequence, and dummy data. The detecting unit 170 detects the occurrence of an error in processing performed by a CPU. The determining unit 160 determines which of the test handler region 121, the test program region 122, the dummy instruction sequence region 123, or the dummy data region 124 the error detected by the detecting unit 170 corresponds to.

The sub memory 130 is a memory apparatus that does not access the cache memory 110. The sub memory 130 holds backups of an instruction sequence and piece of data that the controlling unit 150 is incapable of recovering when a modification is made thereto, from among instruction sequences and pieces of data stored in the main memory 120. In accordance with an implementation, the sub memory 130 may store an instruction sequence and piece of data that, even when a modification is made thereto, the controlling unit 150 can recover to re-create an initial setting. An instruction sequence and data stored in the sub memory 130 are not modified in accordance with a change in, for example, data stored in the cache memory 110.

The following will describe an order in which processes are performed in a CPU transaction test in accordance with an embodiment.

(1) The controlling unit 150 generates, in the sub memory 130, a test handler region 132 and a test program region 133, both of which are backups of instruction sequences held in the test handler region 121 and the test program region 122.

(2) The controlling unit 150 generates management information 131 in the sub memory 130. Management information 131 holds the sizes of instruction sequences stored in the test handler region 121, the test program region 122, and the dummy instruction sequence region 123. For each of the instruction sequences stored in the test handler region 121 and the test program region 122, management information 131 further holds, in association with each other, address information of an instruction sequence in the main memory 120 and address information of the sub memory 130, i.e., a memory in which a backup is stored. Management information 131 holds address information of the main memory 120 for each of the instruction sequences held in the dummy instruction sequence region 123.

(3) The controlling unit 150 starts the transaction test. The controlling unit 150 executes a test instruction sequence stored in the test program region 122 and accesses a dummy instruction sequence stored in the dummy instruction sequence region 123 and dummy data stored in the dummy data region 124 on an as-needed basis. In addition, the controlling unit 150 fetches and puts the test instruction sequence, the dummy instruction sequence, and the dummy data in the cache memory 110.

(4) An introducing unit 140 introduces a code that causes an error in processing performed by a CPU. In a process of fetching an instruction sequence and data from any of the test handler region 121, the test program region 122, the dummy instruction sequence region 123, and the dummy data region 124 and putting such an instruction sequence and data in the cache memory 110, the introducing unit 140 introduces a predetermined code into the fetched instruction sequence and data. Introducing the code into an instruction sequence and data destroys the instruction sequence and data. In one possible example, the introducing unit 140 introduces a code once every time a fetching process is performed 20 times.

(5) The detecting unit 170 detects an error that has occurred in processing performed by the CPU. The CPU writes a calculation result of the processing to, for example, a log. The detecting unit 170 detects the error using information stored in the log.

(6) The determining unit 160 analyzes the error detected by the detecting unit 170. The determining unit 160 determines which of the test handler region 121, the test program region 122, the dummy instruction sequence region 123, or the dummy data region 124 an instruction sequence or data that has caused the detected error is stored in.

(7) When an instruction sequence stored in the test handler region 121 has caused the error, the controlling unit 150 executes a predetermined handler instruction sequence. The executed handler instruction sequence includes information indicating that a backup of the instruction sequence stored in the test handler region 121 is stored in the test handler region 132. The controlling unit 150 copies, to the test handler region 121, an instruction sequence held in the test handler region 132 and corresponding to an instruction sequence with an address at which the error has been detected.

(8) When an instruction sequence stored in the test program region 122 has caused the error, the controlling unit 150 executes a predetermined handler instruction sequence. The executed handler instruction sequence includes information indicating that a backup of the instruction sequence stored in the test program region 122 is stored in the test program region 133. The controlling unit 150 copies, to the test program region 122, an instruction sequence held in the test program region 133 and corresponding to an instruction sequence with an address at which the error has been detected.

(9) When a dummy instruction sequence stored in the dummy instruction sequence region 123 has caused the error, the controlling unit 150 executes a predetermined handler instruction sequence. The executed handler instruction sequence includes information indicating that the dummy instruction sequence stored in the dummy instruction sequence region 123 can be self-repaired. For the dummy instruction sequence with an address at which the error has been detected, the controlling unit 150 copies a dummy instruction sequence with another address within the dummy instruction sequence region 123.

(10) When dummy data stored in the dummy data region 124 has caused the error, the controlling unit 150 executes a predetermined handler instruction sequence. The executed handler instruction sequence includes information indicating that the dummy instruction sequence stored in the dummy data region 124 can be self-repaired. For dummy data with an address at which the error has been detected, the controlling unit 150 copies dummy data with another address within the dummy data region 124.

In the CPU transaction test in (3), a test instruction sequence in the test program region 122 may be repeated, i.e., executed a plurality of times. When any of the processes of (7)-(10) is performed, the controlling unit 150 returns the process to (3). Accordingly, the transaction test is restarted after data in the main memory 120 is put back in an initial state. The log is used to detect an error in the process of (5), but this does not limit the method for detecting an error. The introducing unit 140 may perform a process of modifying an instruction sequence and data without introducing a code.

Performing the processes of (1)-(10) allows a test to be continued even when a test instruction sequence that is stored in a memory and that can be cached in a cache memory or an instruction sequence or data for use in the test is destroyed.

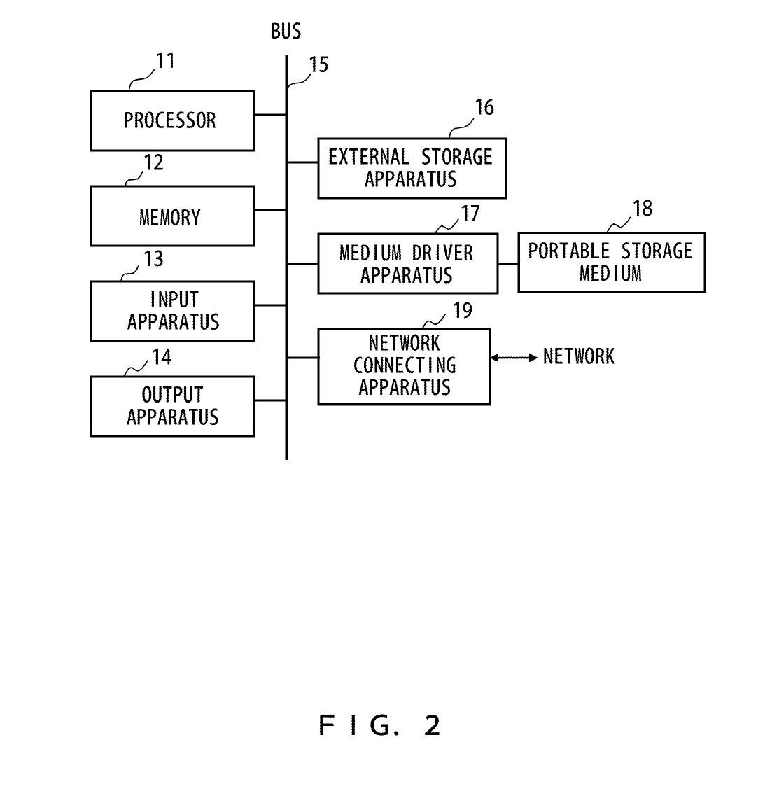

FIG. 2 illustrates an exemplary hardware configuration of a server apparatus. The server apparatus 100 includes a processor 11, a memory 12, a bus 15, an external storage apparatus 16, and a network connecting apparatus 19. In addition, the server apparatus 100 may optionally include an input apparatus 13, an output apparatus 14, and a medium driver apparatus 17. The server apparatus 100 may be achieved by, for example, a computer.

The processor 11 may be a Central Processing Unit (CPU). The processor 11 may be operated as the introducing unit 140, the controlling unit 150, the determining unit 160, and the detecting unit 170. The processor 11 may execute a program stored in, for example, the external storage apparatus 16. The memory 12 may be operated as the main memory 120 and the sub memory 130. The external storage apparatus 16 may be used as the sub memory 130. Data obtained from an operation of the processor 11 and data to be used in processing performed by the processor 11 are also stored in the memory 12 on an as-needed basis. The network connecting apparatus 19 is used for a communication with another apparatus.

The input apparatus 13 is achieved as, for example, a button, keyboard, or mouse. The output apparatus 14 is achieved as, for example, a display. The bus 15 connects the processor 11, the memory 12, the input apparatus 13, the output apparatus 14, the external storage apparatus 16, the medium driver apparatus 17, and the network connecting apparatus 19 so that data can be transmitted and received therebetween. The external storage apparatus 16 stores a program, data, and so on and provides information stored therein to, for example, the processor 11 on an as-needed basis. The medium driver apparatus 17 may output data stored in the memory 12 or the external storage apparatus 16 to a portable storage medium 18 and may read a program, data, and so on from the portable storage medium 18. The portable storage medium 18 may be an arbitrary transportable storage medium such as a floppy disk, Magneto-Optical (MO) disk, Compact Disc Recordable (CD-R), or Digital Versatile Disk Recordable (DVD-R).

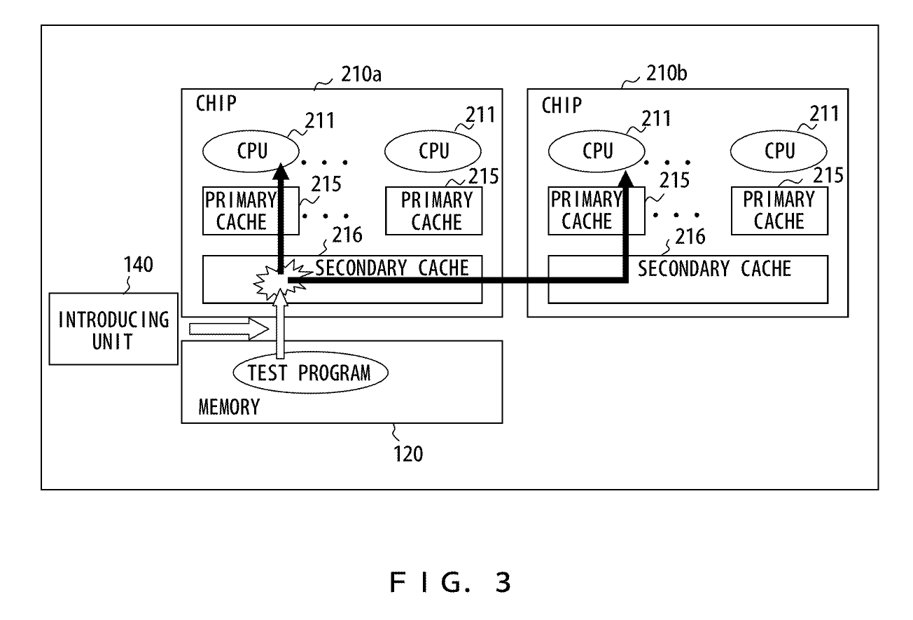

FIG. 3 is an explanatory diagram of an exemplary error case detected in a transaction test. In FIG. 3, like reference numerals refer to like parts depicted in FIG. 1. The server apparatus 100 in FIG. 3 includes the memory 120, the introducing unit 140, and chips 210 (210a, 210b). The chip 210 includes CPUs 211, primary caches 215, and a secondary cache 216. The chip 210 includes one primary cache 215 for each of the CPUs 211. One secondary cache 216 is provided for a plurality of primary caches 215. Note that the server apparatus 100 in FIG. 3 does not limit the numbers of chips, CPUs, primary caches, and secondary caches.

The following will describe examples of error cases detected in a transaction test.

A case where the introducing unit 140 introduces a code into data held in a primary cache 215, and the data into which the code has been introduced is loaded from a CPU 211;
a case where the introducing unit 140 introduces a code into data held in a primary cache 215, and the data into which the code has been introduced is driven out of the primary cache 215;
a case where the introducing unit 140 introduces a code into data held in a secondary cache 216, and the data into which the code has been introduced is loaded from a CPU 211; a case where the introducing unit 140 introduces a code into data held in a secondary cache 216, and the data into which the code has been introduced is driven out of the secondary cache 216;
a case where the introducing unit 140 introduces a code into data held in the secondary cache 216 of the chip 210a, and the data into which the code has been introduced is loaded from the chip 210b;
a case where the introducing unit 140 introduces a code into data held in the secondary cache 216 of the chip 210a, and the data into which the code has been introduced is loaded from a CPU 211 of the chip 210b; and
a case where the introducing unit 140 introduces a code into data held in a primary cache 215, and the data into which the code has been introduced is loaded from a CPU that is different from the CPU 211 associated with the primary cache 215.

When, for example, a CPU 211 processes data having introduced thereinto a code that causes an error in processing performed by a CPU, the CPU 211 writes a calculation result indicating an error to a log. The detecting unit 170 detects the error using information in the log. Note that “data is driven out” means that data that is not to be used, data of a low frequency of use, or the like is cleared when a cache memory becomes full so that new data can be written. Data driven out of a primary cache 215 or a secondary cache 216 is written to the main memory 120. The CPU 211 performs such a process, i.e., a write-back process for writing data that has been driven out to the main memory 120. When data driven out of a primary cache 215 or a secondary cache 216 is inconsistent with data held in the main memory 120, the CPU 211 writes information indicating an error to the log.

Error cases detected in a cache memory in a transaction test are not limited to those described above. In a CPU transaction test, the test instruction sequence held in the test program region 122 in FIG. 1 is created in advance for each error case to be inspected. Data may be driven out of a primary cache 215 or a secondary cache 216 by increasing the number of dummy instruction sequences or the number of pieces of dummy data.

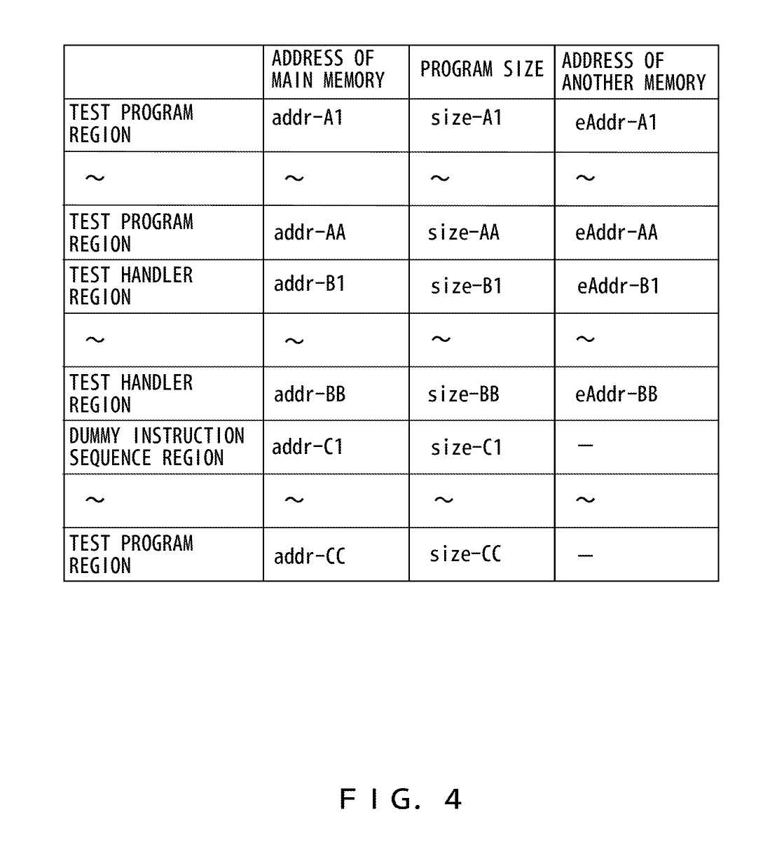

FIG. 4 is an explanatory diagram of an example of management information in accordance with an embodiment. For each of the instruction sequences stored in the test handler region 121 and the test program region 122, management information 131 holds, in association with each other, address information of an instruction sequence in the main memory 120 and address information of the sub memory 130, i.e., a memory in which a backup is stored. Management information 131 in FIG. 4 holds, for example, addr-A1 to addr-AA as address information of the main memory 120, i.e., a memory in which test instruction sequences held in the test program region 122 are stored. Management information 131 holds eAddr-A1 to eAddr-AA as address information of the sub memory 130, i.e., a memory in which backups of test instruction sequences are stored. Management information 131 also holds addr-B1 to addr-BB as address information of the main memory 120, i.e., a memory in which handler instruction sequences held in the test handler region 121 are stored. Management information 131 holds eAddr-B1 to eAddr-BB as address information of the sub memory 130, i.e., a memory in which backups of handler instruction sequences are stored. In addition, management information 131 holds information indicating the sizes of instruction sequences stored in the test handler region 121 and the test program region 122.

After the detecting unit 170 detects an error from the log, the controlling unit 150 and the determining unit 160 use management information 131. When the detecting unit 170 detects an error, the determining unit 160 analyzes the error. The log includes address information in the main memory 120 and related to an instruction sequence or data that has caused the error. Accordingly, the determining unit 160 obtains, in accordance with information in the log, address information for which the error has been detected, and determines which of the test handler region 121, the test program region 122, the dummy instruction sequence region 123, or the dummy data region 124 the instruction sequence or data that has caused the detected error is held in. To determine a region that is a cause of the error, the determining unit 160 compares address information for which the error has been detected from the log with management information 131.

When a cause of the detected error is an instruction sequence held in the test handler region 121 or the test program region 122, the controlling unit 150 executes a predetermined handler instruction sequence corresponding to the test handler region 121 or the test program region 122. The executed predetermined handler instruction sequence includes information indicating that a backup of the instruction sequence held in the test handler region 121 or the test program region 122 is stored in the sub memory 130. Using management information 131, the controlling unit 150 copies the instruction sequence for which a backup has been made to the main memory 120.

For each instruction sequence held in the dummy instruction sequence region 123, management information 131 holds the size of the instruction sequence and address information of the main memory 120. Management information 131 in FIG. 4 holds, for example, addr-C0 to addr-Cn as address information of the main memory 120, i.e., a memory in which instruction sequences held in the dummy instruction sequence region 123 are stored.

When a cause of the detected error is an instruction sequence held in the dummy instruction sequence region 123, the controlling unit 150 executes a predetermined handler instruction sequence corresponding to the dummy instruction sequence region 123. The executed handler instruction sequence includes information indicating that a dummy instruction sequence held in the dummy instruction sequence region 123 can be self-repaired. The controlling unit 150 selects an instruction sequence that is different from the instruction sequence that includes an address corresponding to a cause of the error, and copies the selected instruction sequence to the instruction sequence that includes the address corresponding to a cause of the error. A method for performing self recovery is not limited to a method that includes selecting an instruction sequence that is different from the instruction sequence that includes an address corresponding to a cause of the error, and copying the selected instruction sequence to the instruction sequence that includes an address corresponding to a cause of the error. As long as an instruction sequence can be repaired using an instruction sequence or data held in the main memory 120, any method may be used as a method for performing self recovery.

In an embodiment, for each of the instruction sequences included in the test program region, the test handler region, and the dummy instruction sequence region, management information 131 holds a starting address of a memory in which the instruction sequence is stored.

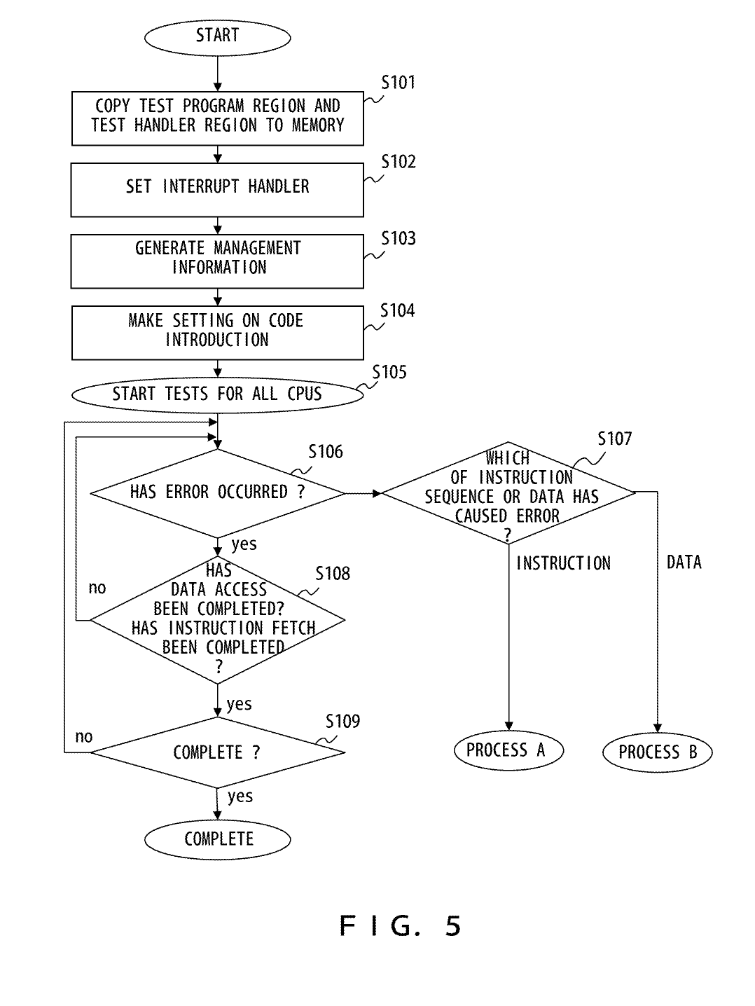

FIG. 5 is a flowchart illustrating an example of a CPU transaction test in accordance with an embodiment (example 1). The test handler region 121, the test program region 122, the dummy instruction sequence region 123, and the dummy data region 124 are provided within the main memory 120 in advance.

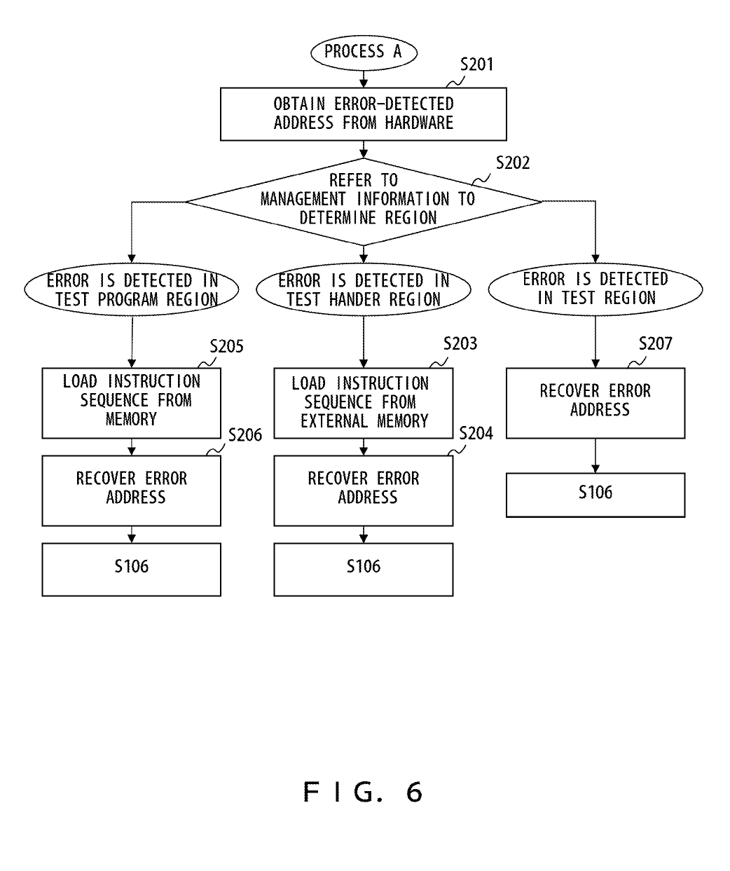

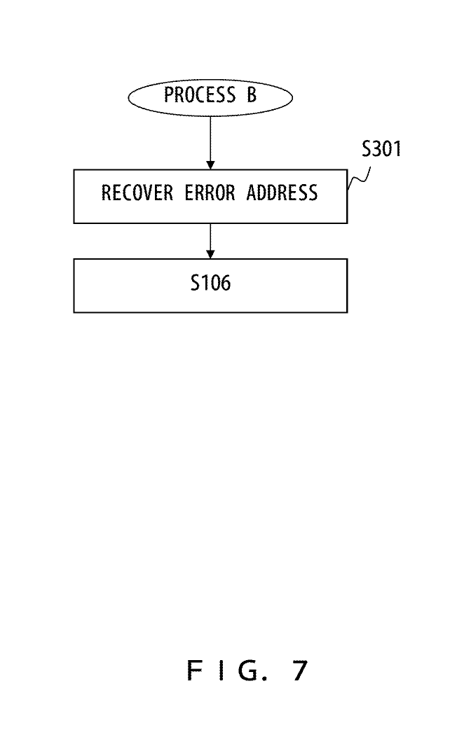

The controlling unit 150 generates, in the sub memory 130, the test handler region 132 and the test program region 133, which are backups of the test handler region 121 and the test program region 122 (step S101). For each region where an error is expected to occur, the controlling unit 150 obtains setting information of a handler instruction sequence to be executed by the controlling unit 150 (step S102). The controlling unit 150 generates management information 131 within the sub memory 130 (step S103). The controlling unit 150 obtains information on the frequency of code introduction to be set for the introducing unit 140 (step S104). The controlling unit 150 starts a CPU transaction test (step S105). The detecting unit 170 checks a log generated through processing performed by a CPU and determines whether an error has occurred (step S106). The determining unit 160 determines which of an instruction sequence or data has caused an error (step S107; YES in step S106). When an instruction sequence is a cause of the error, the flow shifts to the flowchart of a process A (FIG. 6). When data is a cause of the error, the flow shifts to the flowchart of a process B (FIG. 7). The controlling unit 150 determines whether all of the instruction sequences and data held in the dummy instruction sequence region 123 and the dummy data region 124 have been used (step S108; NO in step S106). The controlling unit 150 determines whether all of the test instruction sequences held in the test program region 122 have been executed (step S109; YES in step S108). When a determination of NO is indicated in steps S108 and S109, the flow repeats starting from S106. When a determination of YES is indicated in step S109, the controlling unit 150 ends the transaction test.

FIG. 6 is a flowchart illustrating an example of a CPU transaction test in accordance with an embodiment (example 2). FIG. 6 is a flowchart depicting an example of the process A, which is performed when an instruction sequence is judged to be a cause of an error in S107 in FIG. 5. The determining unit 160 obtains error information from a log (step S201). The determining unit 160 refers to management information 131 to determine which of the test handler region 121, the test program region 122, or the dummy instruction sequence region 123 an instruction sequence indicated by address information included in the error information is included in (step S202). When an instruction sequence held in the test handler region 121 has caused the error, the controlling unit 150 executes a predetermined handler instruction sequence. The executed handler instruction sequence includes information indicating that a backup of the instruction sequence held in the test handler region 121 is stored in the test handler region 132. The controlling unit 150 loads an instruction sequence held in the test handler region 132 and corresponding to the instruction sequence with an address at which the error has been detected (step S203). The controlling unit 150 writes the instruction sequence loaded from the test handler region 132 at the address at which the error has been detected (step S204). When the process of S204 ends, the controlling unit 150 returns the flow to S106 in FIG. 5.

When an instruction sequence held in the test program region 122 has caused the error, the controlling unit 150 executes a predetermined handler instruction sequence. The executed handler instruction sequence includes information indicating that a backup of the instruction sequence held in the test program region 122 is stored in the test program region 133. The controlling unit 150 loads an instruction sequence held in the test program region 133 and corresponding to the instruction sequence with an address at which the error has been detected (step S205). The controlling unit 150 writes the instruction sequence loaded from the test program region 133 at the address at which the error has been detected (step S206). When the process of S206 ends, the controlling unit 150 returns the flow to S106 in FIG. 5.

When a dummy instruction sequence stored in the dummy instruction sequence region 123 has caused the error, the controlling unit 150 executes a predetermined handler instruction sequence. The executed handler instruction sequence includes information indicating that the dummy instruction sequence stored in the dummy instruction sequence region 123 can be self-repaired. To the dummy instruction sequence with an address at which the error has been detected, the controlling unit 150 copies a dummy instruction sequence with another address within the dummy instruction sequence region 123 (step S207). When the process of S207 ends, the controlling unit 150 returns the flow to S106 in FIG. 5.

FIG. 7 is a flowchart illustrating an example of a CPU transaction test in accordance with an embodiment (example 3). FIG. 7 is a flowchart depicting an example of the process B, which is performed when data is judged to be a cause of an error in S107 in FIG. 5.

When dummy data stored in the dummy data region 124 has caused the error, the controlling unit 150 executes a predetermined handler instruction sequence. The executed handler instruction sequence includes information indicating that the dummy instruction sequence stored in the dummy data region 124 can be self-repaired. To the dummy data with an address at which the error has been detected, the controlling unit 150 copies dummy data with another address within the dummy data region 124 (step S301). When the process of S301 ends, the controlling unit 150 returns the flow to S106 in FIG. 5.

As described above, in the methods in accordance with the embodiments, even when a test instruction sequence that is stored in a memory and can be cached in a cache memory or an instruction sequence or data for use in a test is destroyed, another memory apparatus that does not access the cache holds a backup. Restoring destroyed data from the backup allows the test to be continued without interruption.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for testing an information processing apparatus, the method comprising:
making, in a second memory and by a first processor of the information processing apparatus that includes a cache memory, a first memory, and the second memory, the first processor, and a second processor, backups of a first instruction sequence and first data that, when a modification is made thereto, is incapable of being recovered using an instruction sequence held in the first memory from among the instruction sequence and data that is held in the first memory and that is to be used to process the instruction sequence, the second memory being not accessed by the cache memory;
in causing the second processor to execute the instruction sequence held in the first memory, modifying, by the first processor at predetermined timings, a second instruction sequence and second data that is held in the first memory and that is fetched and put in the cache memory;
while the second processor is executing the instruction sequence held in the first memory, when an error occurs due to a modification in a third instruction sequence that is incapable of being recovered using the instruction sequence held in the first memory, writing, to the first memory and by the first processor, the first instruction sequence for which a backup has been made in the second memory; and
when an error occurs due to a modification in a fourth instruction sequence or fourth data that is capable of being recovered using the instruction sequence and the data held in the first memory, recovering, by the first processor, the fourth instruction sequence or the fourth data that is a cause of the error using the instruction sequence and the data held in the first memory.

2. The method for testing the information processing apparatus according to claim 1, wherein
the error occurs when the second processor processes a modified instruction sequence and modified data or when the modified instruction sequence and the modified data are inconsistent with the instruction sequence and the data before the modification held in the first memory in a process of writing the modified instruction sequence and the modified data to the first memory.

3. An information processing apparatus comprising:
a cache memory;
a first memory configured to hold an instruction sequence fetched and put in the cache memory and data to be used to process the instruction sequence;
a second memory configured to not be accessed by the cache memory;
a first processor configured to
make, in the second memory, backups of a first instruction sequence and first data that, when a modification is made thereto, is incapable of being recovered using the instruction sequence held in the first memory from among the instruction sequence and the data that is held in the first memory and that is to be used to process the instruction sequence,
subsequently cause a second processor to execute the instruction sequence held in the first memory, and
modify, at predetermined timings, a second instruction sequence and second data that is held in the first memory and that is fetched and put in the cache memory; and
the second processor, wherein
the first processor
while the second processor is executing the instruction sequence held in the first memory, when an error occurs due to a modification in a third instruction sequence that is incapable of being recovered using the instruction sequence held in the first memory, writes, to the first memory, the first instruction sequence for which a backup has been made in the second memory, and
when an error occurs due to a modification in a fourth instruction sequence or fourth data that is capable of being recovered using the instruction sequence and the data held in the first memory, recovers the fourth instruction sequence or the fourth data that is a cause of the error using the instruction sequence and the data held in the first memory.

4. The information processing apparatus according to claim 3, wherein
the error occurs when the second processor processes a modified instruction sequence and modified data or when the modified instruction sequence and the modified data are inconsistent with the instruction sequence and the data before the modification held in the first memory in a process of writing the modified instruction sequence and the modified data to the first memory.

5. A computer-readable recording medium having stored therein a test program for causing a first processor to execute a process comprising:
making, in a second memory of the information processing apparatus that includes a cache memory, a first memory, and the second memory, the first processor, and a second processor, backups of a first instruction sequence and first data that, when a modification is made thereto, is incapable of being recovered using an instruction sequence held in the first memory from among the instruction sequence and data that is held in the first memory and that is to be used to process the instruction sequence, the second memory being not accessed by the cache memory;
in causing the second processor to execute the instruction sequence held in the first memory, modifying, at predetermined timings, a second instruction sequence and second data that is held in the first memory and that is fetched and put in the cache memory;
while the second processor is executing the instruction sequence held in the first memory, when an error occurs due to a modification in a third instruction sequence that is incapable of being recovered using the instruction sequence held in the first memory, writing, to the first memory, the first instruction sequence for which a backup has been made in the second memory; and
when an error occurs due to a modification in a fourth instruction sequence or fourth data that is capable of being recovered using the instruction sequence and the data held in the first memory, recovering the fourth instruction sequence or the fourth data that is a cause of the error using the instruction sequence and the data held in the first memory.

6. The computer-readable recording medium according to claim 5, wherein
the second processor determines that the error has occurred when the second processor processes a modified instruction sequence and modified data or when the modified instruction sequence or the modified data are inconsistent with the instruction sequence or the data before the modification held in the first memory in a process of writing the modified instruction sequence and the modified data to the first memory.
